(19) United States
(12) Patent Application Publication
(10) Pub. No.: US 2023/0190059 A1
(43) Pub. Date: Jun. 22, 2023

(54) TUBE ARRANGEMENT AND TELESCOPIC EXTENSION FOR AN ELECTRIC HOUSEHOLD APPLIANCE COMPRISING SUCH A TUBE ARRANGEMENT

(71) Applicant: OMEC S.r.l., Gorla Minore (IT)

(72) Inventor: Stefano CANALE, Gorla Minore (IT)

(21) Appl. No.: 18/086,399

(22) Filed: Dec. 21, 2022

(30) Foreign Application Priority Data
Dec. 22, 2021 (IT) 102021000032213

(51) Int. Cl. A47L 9/24

(52) U.S. Cl. CPC A47L 9/244; A47L 9/248

(57) ABSTRACT

A tube arrangement is described, said arrangement comprising:
an inner tube and an outer tube telescopically slidable relative to each other; wherein the inner tube comprises, on an outer surface thereof, a longitudinal groove and a plurality of deformations having a predetermined shape;
a sleeve fitted into the outer tube, at one of its ends;
a fastening device configured to prevent sliding of the inner tube with respect to the outer tube, when said fastening device is at least partially engaged in one of said deformations;
a slider and elastic means, wherein the slider cooperates with the fastening device under the action of the elastic means; and
an actuating device operatively connected to the slider;
wherein the longitudinal groove forms, at one end of the inner tube, a slide inclined towards the longitudinal axis of the inner tube for separating the inner tube from the outer tube.

### BACKGROUND

The present invention relates to the sector of electric household appliances and in particular to the sector of tubes and telescopic extensions for an electric household appliance, such as a vacuum cleaner, a drum vacuum cleaner, an electric broom, a carpet cleaner, a cyclone vacuum cleaner or a similar apparatus. The present invention relates more particularly to a telescopic extension in which the outer tube may be separated from the inner tube. The present invention also relates to an electric household appliance comprising such a telescopic tube.

### PRIOR ART

Telescopic extensions for electric household appliances are known, in which an inner tube and an outer tube are configured to slide in a sealed manner one inside the other and assume a plurality of positions between a completely closed configuration and a completely extended configuration.

EP 1,092,383, WO 02/38026 A1, EP 3,210,515 A1, EP 0,987,976 A1 and EP 0,520,534 A1 describe telescopic extensions for an electric household appliance.

Based on the suction direction in a telescopic extension an input end and an output end are identified. The input end is typically removably fixed to a suction tool such as a so-called vacuum cleaner brush or vacuum cleaner nozzle (or head). The brush slides over the surface to be cleaned and sucks up solids or liquids such as dust, debris, crumbs or water. The material sucked up from the ground enters into the telescopic extension through the input end and exits the telescopic extension through the output end. Downstream of the telescopic extension the material sucked up from the ground is collected, passing optionally through another tube, for example a rigid or flexible tube of the spiralled type.

Similarly, depending on the suction direction, an input end and an output end are also identified for the inner tube and outer tube. In fact, the input end of the inner tube corresponds to the input end of the telescopic extension and the output end of the outer tube coincides with the output end of the telescopic extension.

A known telescopic extension, as mentioned above, comprises an inner tube and an outer tube. The minimum dimension of a telescopic extension is that defined when the inner tube is completely retracted inside the outer tube.

### SUMMARY OF THE INVENTION

The inventor has observed that, typically, the telescopic extension is supplied together with a vacuum cleaner. In other words, the telescopic extension forms part of the primary equipment of a vacuum cleaner. The minimum dimension of a telescopic extension therefore influences the dimensions of the packaging inside which a vacuum cleaner is inserted for despatch from the production site to the public sales outlet.

Often, the height of the vacuum cleaner is smaller than the length of the telescopic extension also when the latter is closed, namely when the inner tube is completely retracted inside the outer tube.

The abovementioned problem occurs, in particular, for example, when the telescopic extension has curved sections, for example a form with a double curvature.

The dimensions of a telescopic extension are also important following purchase by a user since the user must store the vacuum cleaner in a space which is also able to accommodate the telescopic extension. If the telescopic extension is long, a correspondingly large space is required.

The inventor has defined the object of solving, at least partly, the aforementioned problems and providing a telescopic extension in which the two main components, namely the inner tube and the outer tube, can if necessary be separated from each other.

According to a first aspect of the present invention, a tube arrangement is provided, said arrangement comprising:
a) an inner tube and
b) an outer tube
   wherein the inner tube and the outer tube are telescopically slidable relative to one another,
   wherein the inner tube comprises, on an outer surface thereof, a longitudinal groove and a plurality of deformations having a predetermined shape;
c) a sleeve fitted into said outer tube, at one of its ends;
d) a fastening device configured to prevent sliding of the inner tube with respect to the outer tube, when said fastening device is at least partially engaged in one of said deformations;
e) a slider and elastic means, wherein the slider cooperates with the fastening device under the action of the elastic means; and
f) an actuating device operatively connected to the slider,
   wherein the longitudinal groove forms, at one end of the inner tube, a slide inclined towards the longitudinal axis of the inner tube for separating the inner tube from the outer tube.

The tube arrangement may also comprise a retaining member for preventing accidental separation of the inner tube from the outer tube.

The retaining member may also comprise a tooth projecting outwards from the inner tube.

The tooth may be arranged in a position diametrically opposite the longitudinal groove.

The inner tube may be connected to an accessory for a vacuum cleaner.

According to another aspect, the present invention relates to a telescopic extension for a vacuum cleaner comprising a tube arrangement as described above.

According to another aspect, the present invention relates to a vacuum cleaner comprising a telescopic extension of the aforementioned type and/or a tube arrangement of the type described above.

### BRIEF DESCRIPTION OF THE DRAWINGS

The present invention will become clear from the following detailed description of examples of embodiment, to be read with reference to the attached figures, in which:

- FIG. 1 is an axonometric view of an example of embodiment of a telescopic extension in its completely open or extended configuration;

- FIG. 2 is an axonometric view of the telescopic extension of claim 1 in its completely closed or retracted configuration;

- FIG. 3 is an exploded view of the telescopic extension according to FIGS. 1 and 2;

- FIG. 4 is a side view of the telescopic extension according to FIGS. 1 and 2 in the disassembled condition;

- FIG. 4.1, FIG. 4.2 and FIG. 4.3 are further views, on a larger scale, of the inner tube;

- FIG. 5 is a view, on a larger scale, of the output section of the inner tube and the input section of the outer tube;

- FIG. 6 is an axonometric view of a sleeve suitable for the telescopic extension of the invention;

- FIG. 7 is a cross-section though a portion of the telescopic extension according to FIGS. 1 and 2;

- FIG. 8 is a cross-section through a portion of the inner tube which shows the sealing gasket on the inner tube, called “mushroom” and FIG. 8.1 is an enlarged detail of FIG. 8; and

- FIG. 9 shows the connection between a tube and an accessory according to the solution of the present invention.

### DESCRIPTION OF EXAMPLES

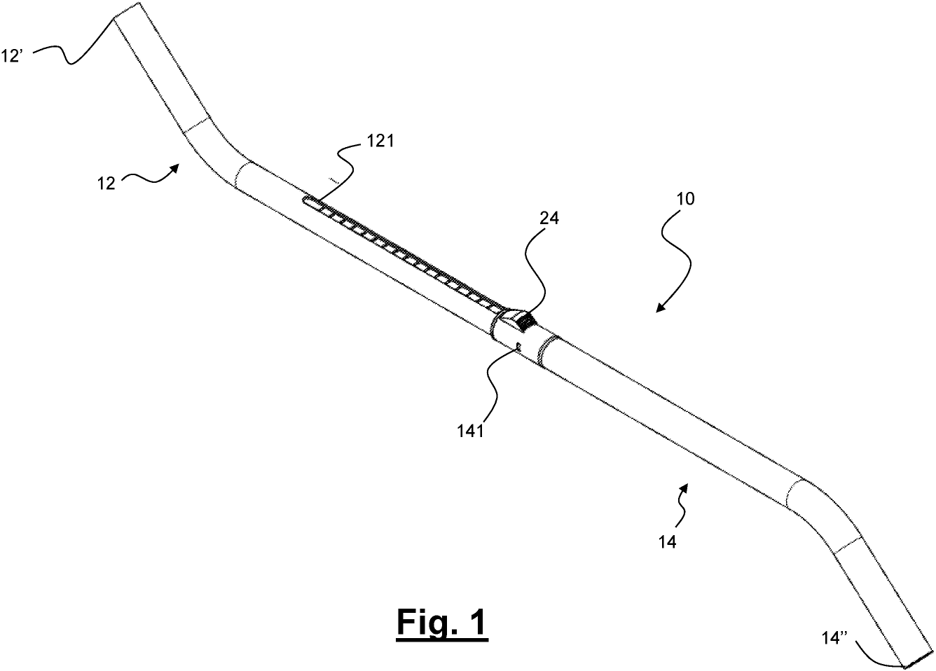

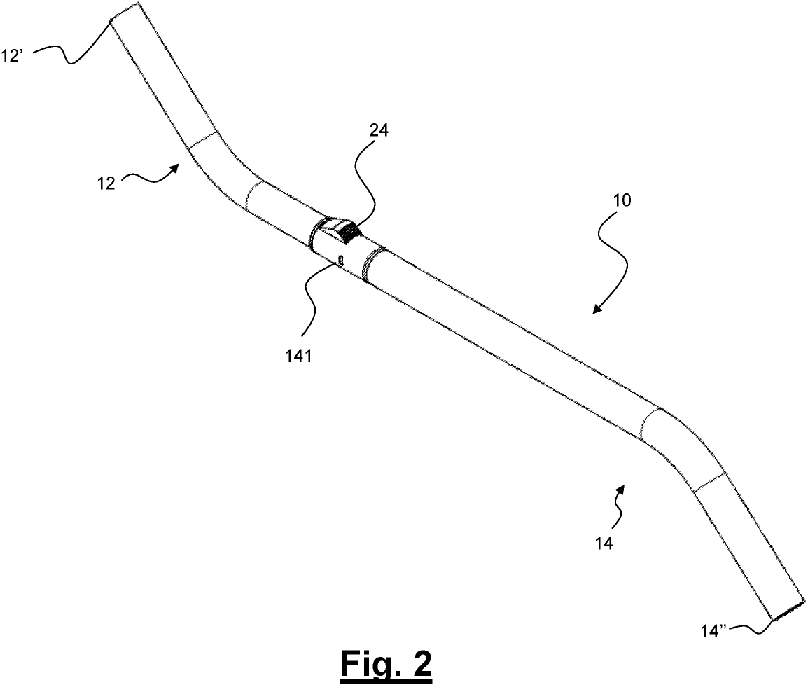

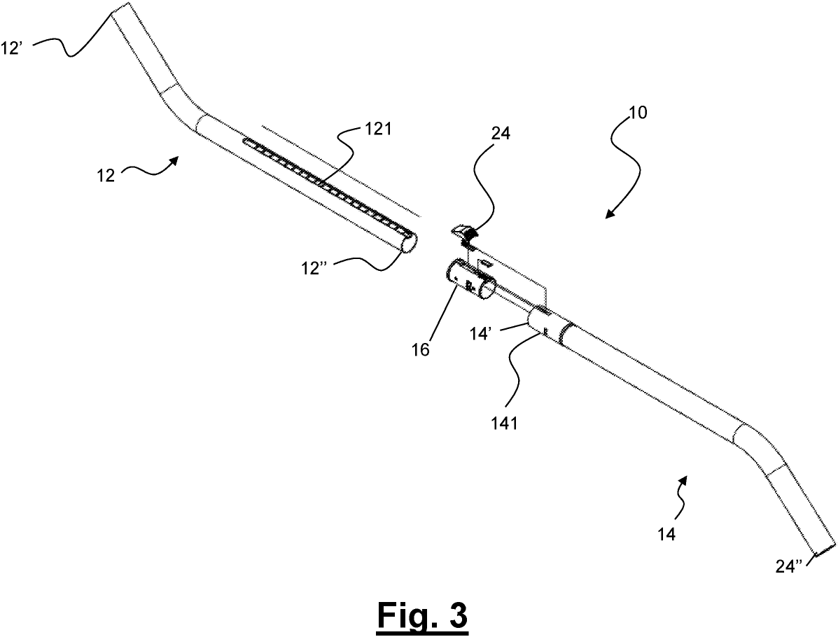

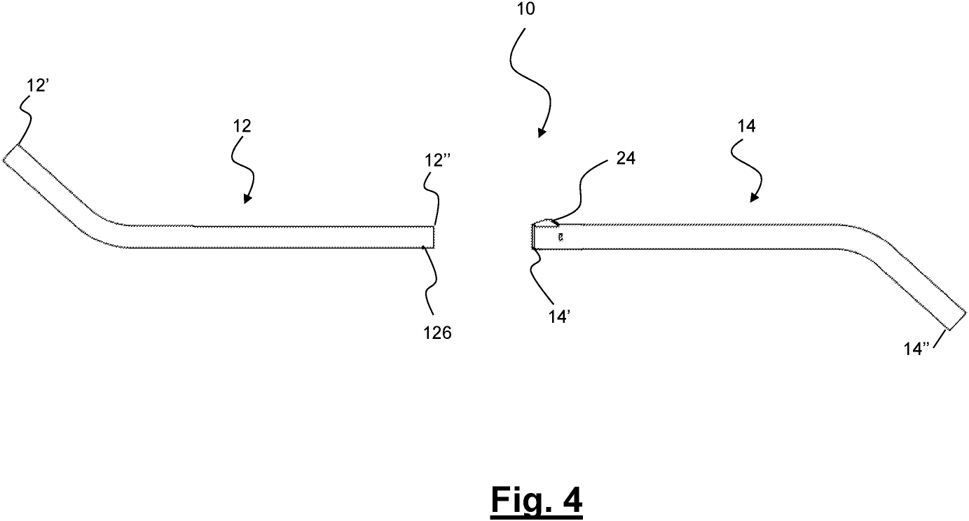

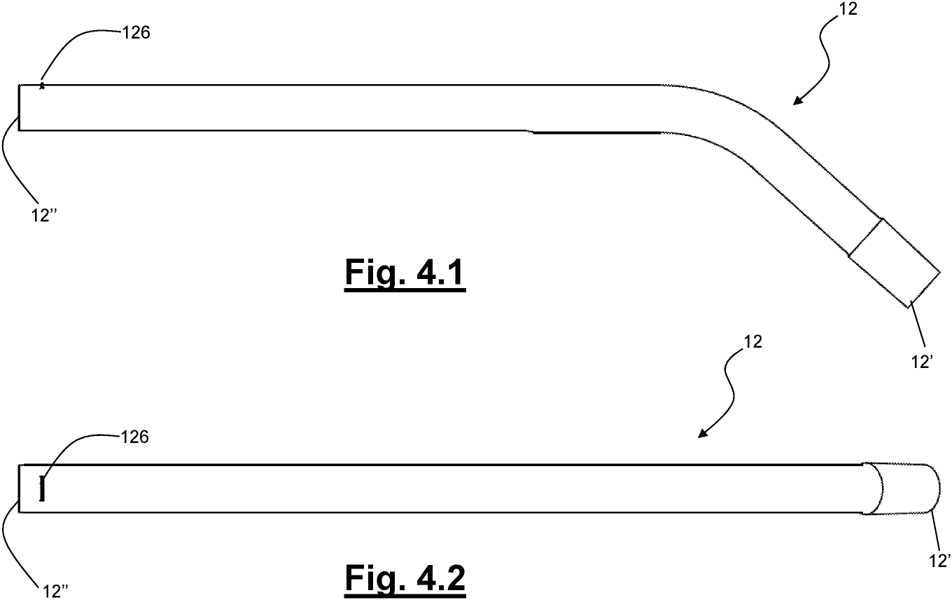

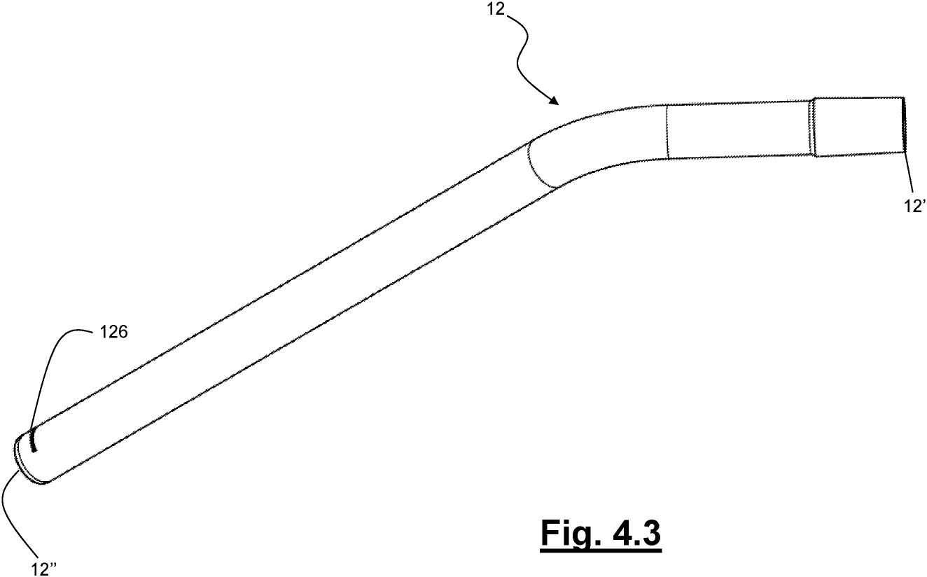

FIGS. 1-4, 4.1, 4.2 and 4.3 show an embodiment of a telescopic extension according to the present invention. The telescopic extension 10 comprises an inner tube 12 and an outer tube 14, a sleeve 16 with a mechanism for locking the outer tube and the inner tube relative to each other in a plurality of predetermined positions. By way of example, when the telescopic extension is mounted, it forms a double curve. This form allows a certain type of use, but results in the telescopic extension being awkward and bulky even when it is completely closed (FIG. 2).

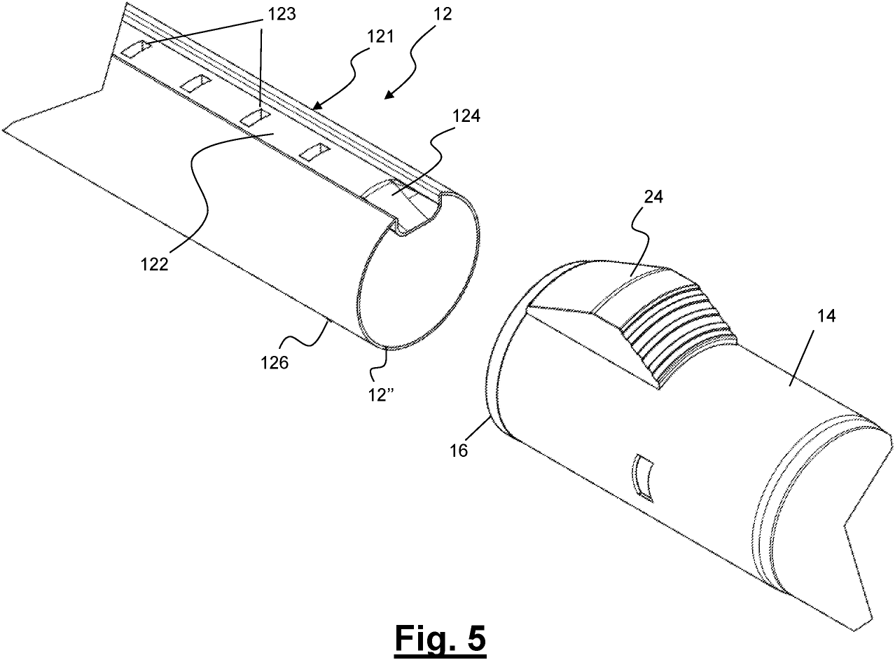

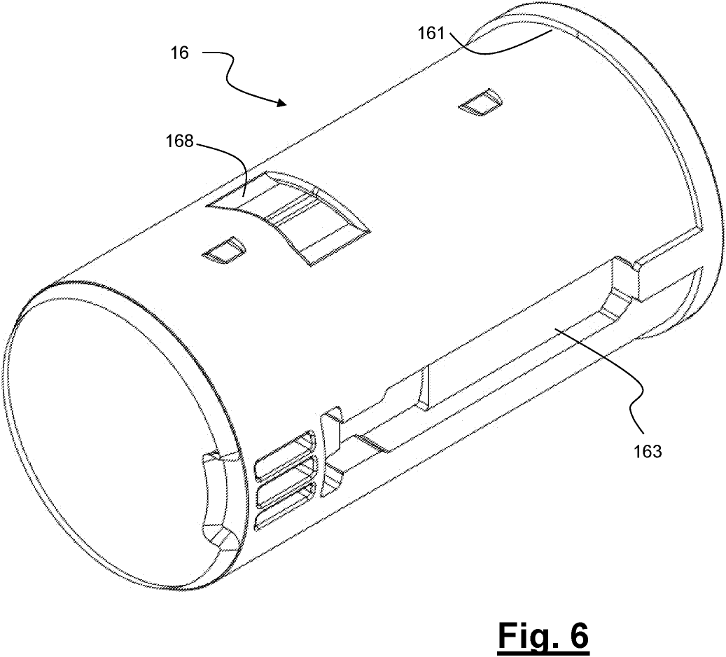

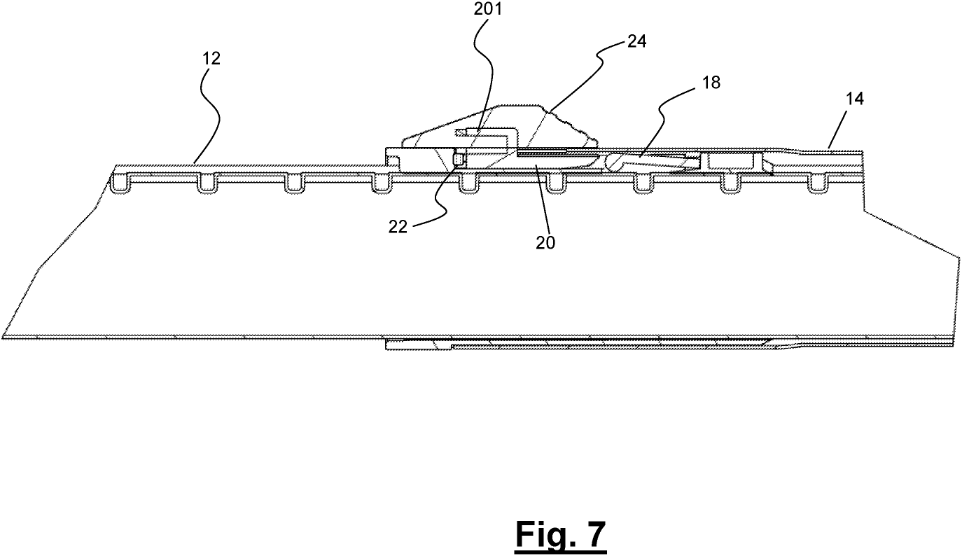

As shown in FIGS. 5, 6 and 7, a sleeve 16 is mounted on the outer tube 14 and is interposed between the inner tube 12 and the outer tube 14. The sleeve 16 comprises a fastening member 18, a pushing slider 20, an elastic member 22 and an actuating device 24.

The inner and outer tubes 12 and 14 are slidable in a sealed manner one inside the other. Preferably a sealing gasket 26 may be inserted between the inner tube 12 and the outer tube 14. The tubes 12 and 14 are made, for example, of chrome-plated or externally painted sheet stainless steel. Alternatively, they may be made of any metal.

The inner tube 12 has a first end (or input end) 12′ and a second end (or output end) 12″. The outer tube 14 has a first end (or input end) 14′ and a second end (or output end) 14″. The telescopic extension 10 therefore has as input end the input end 12′ of the inner tube 12 and as output end the output end 14″ of the outer tube 14.

The inner tube 12 has preferably a longitudinal groove 121, which is substantially parallelepiped-shaped, with a bottom wall 122 in which a row of notches 123 is formed. Preferably, the notches 123 have a partially cylindrical form and are configured to house a portion of the fastening member 18, as will be described below.

The sleeve 16 is designed to be inserted in the input end 14′ of the outer tube 14. Preferably, the sleeve 16 comprises a substantially cylindrical body with a circular reinforcing collar 161 at its input end.

Preferably, the sleeve 16 comprises a longitudinal cavity 163.

Preferably, the fastening member 18 comprises a metal plate shaped in the form of a T or double T.

The slider 20 comprises a projecting part 201 configured to engage with the actuating member 24 which may be for example a shaped button for pushing the slider in one direction or the opposite direction.

Preferably, the sleeve 16 also comprises one or more openings 168 for cooperating with one or more corresponding saw teeth 141 present in the wall of the outer tube 14 and locking the sleeve to the outer tube, preventing it from coming out. Preferably there are two diametrically opposite openings 168 and two saw teeth 141.

According to the present invention, the longitudinal groove 121 is substantially flat over its entire length, but is inclined downwards (namely towards the centre of the inner tube) and forms a slide 124 at the output end 12″ of the inner tube 12. This makes it possible to separate completely the inner tube 12 from the outer tube 14. Obviously, the connection between outer tube and inner tube is reversible and the two tubes may be connected together again.

FIG. 5 shows the output end 12″ of the inner tube 12 with the end section of the groove 121 which forms the slide 124. The inclined wall of the slide may have a length of a few millimetres, for example 5-10 mm.

In order to prevent a user from accidentally extracting the inner tube 12 from the outer tube 14, advantageously a retaining member is provided. The retaining member 126 forces the user to exert a greater force in order to overcome the resistance of the retaining member. For example, the retaining member 126 could comprise one or more teeth projecting outwards from the inner tube. For example, the retaining member 126 could comprise a -preferably rounded - tooth projecting outwards from the inner tube 12 in a position diametrically opposite to the groove 121.

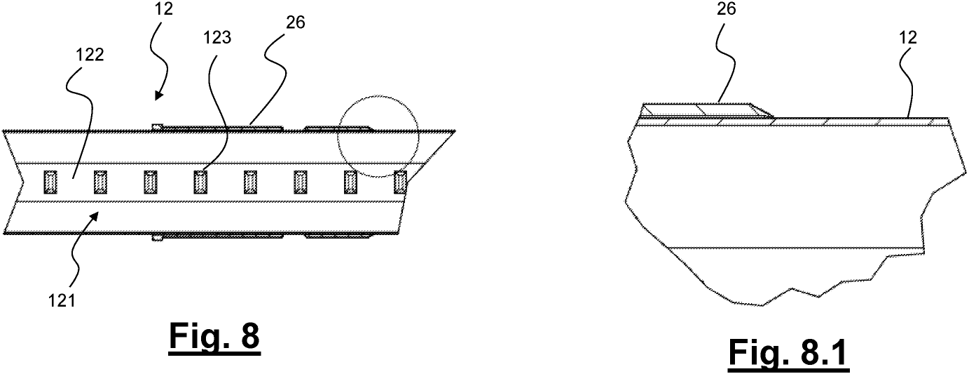

FIGS. 8 and 8.1 show the sealing gasket 26 (also called “mushroom”) between the outer tube and the inner tube.

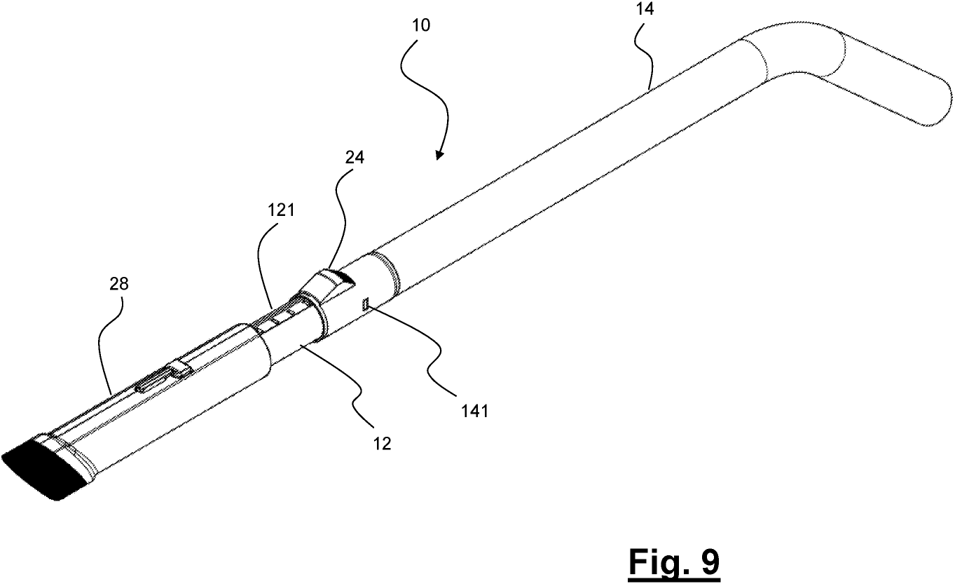

FIG. 9 shows an accessory for a vacuum cleaner. The accessory 28 comprises a small brush, the opposite end of which is shaped substantially like the inner tube of the telescopic extension of FIGS. 1 and 2. Basically, the output end of the accessory 28 comprises a tube section with a groove 121 having one or more recesses. According to preferred embodiments, a retaining member is provided for indicating to the user that the accessory is being separated from the outer tube.

1. A tube arrangement comprising:
a) an inner tube and
b) an outer tube
wherein said inner tube and said outer tube are telescopically slidable relative to each other,
wherein said inner tube comprises, on its outer surface, a longitudinal groove and a plurality of deformations having a predetermined shape;
c) a sleeve fitted into said outer tube, at one of its ends;
d) a fastening device configured to prevent the sliding of the inner tube with respect to the outer tube, when said fastening device is engaged at least partially in one of said deformations;
e) a slider and elastic means, wherein said slider cooperates with said fastening device under the action of said elastic means; and
f) an actuating device operatively connected to said slider,
wherein said longitudinal groove forms, at an end of the inner tube, a slide inclined towards the longitudinal axis of the inner tube for separating the inner tube from the outer tube.

2. The tube arrangement of claim 1, further comprising a retaining member for preventing accidental separation of the inner tube from the outer tube.

3. The tube arrangement of claim 2, wherein said retaining member comprises a tooth protruding outwards from the inner tube.

4. The tube arrangement of claim 3, wherein said tooth is disposed in a position diametrically opposite to the longitudinal groove.

5. The tube arrangement of claim 1, wherein the inner tube is connected to an accessory for a vacuum cleaner.

6. A telescopic extension for a vacuum cleaner comprising a tube arrangement according to claim 1.

7. A vacuum cleaner comprising a telescopic extension according to claim 6 and/or a tube arrangement.
